(19) United States
(12) Patent Application Publication
(10) Pub. No.: US 2026/0048731 A1
(43) Pub. Date: Feb. 19, 2026

(54) METHOD AND APPARATUS FOR CONTROLLING DRIVING OF HYBRID ELECTRIC VEHICLE

(71) Applicants: HYUNDAI MOTOR COMPANY, SEOUL (KR); KIA CORPORATION, SEOUL (KR)

(72) Inventors: Jin Kyeom CHO, Hwaseong-si (KR); Chi Ho MOON, Hwaseong-si (KR); Gyu Ri LEE, Hwaseong-si (KR); Seok Cheon JEON, Hwaseong-si (KR); Sun Woo KIM, Hwaseong-si (KR); Ji Hoon KANG, Hwaseong-si (KR); Dong Hyeon WOO, Hwaseong-si (KR)

(21) Appl. No.: 18/954,800

(22) Filed: Nov. 21, 2024

(30) Foreign Application Priority Data
Aug. 19, 2024 (KR) 10-2024-0110755

(51) Int. Cl. B60W 20/16; B60W 50/10; B60W 50/14

(52) U.S. Cl. CPC B60W 20/16; B60W 50/10; B60W 50/14; B60W 2050/146; B60W 2510/244

(57) ABSTRACT

A method of controlling driving includes receiving information about a current driving road, when existence of at least one of a first section and a second section where exhaust gas emissions are limited is determined based on the received information, determining whether driving is possible in a first mode of driving using only an electric motor in the section determined as existing, and outputting information about the section determined as existing in consideration of whether driving is possible in the first mode, wherein the first section is set by a driver and the second section is set in advance based on information set in advance in an external server or a memory of the vehicle.

### CROSS REFERENCE TO RELATED APPLICATION

The present application claims priority to Korean Patent Applications No. 10-2024-0110755, filed Aug. 19, 2024, the entire contents of which are incorporated herein for all purposes by this reference.

### BACKGROUND

### Technical Field

The present disclosure relates to a method and apparatus for controlling driving of a hybrid electric vehicle and, in more detail, to a method and apparatus for controlling driving modes of an eco-friendly vehicle in specific road regions by a driver.

### Description of the Related Art

Recently, eco-friendly vehicles equipped with an electric motor as a power source are increasing with an increase of the interest in the environment. An eco-friendly vehicle is also called an electrified vehicle, and a Hybrid Electric Vehicle (HEV) or an Electric Vehicle (EV) is representative of eco-friendly vehicles.

A hybrid electric vehicle generally refers to a vehicle that uses both of two types of power sources and the two types of power sources are usually an engine and an electric motor. Such hybrid electric vehicles not only have high fuel efficiency and power performance, but are advantageous in reduction of exhaust gases in comparison to vehicles equipped with only an internal combustion engine, so hybrid electric vehicles are recently extensively developed.

Such hybrid electric vehicles can be operated in two types of driving modes, depending on which powertrain is driven. One of them is an electric vehicle (EV) mode in which driving is performed by only an electric motor and the other one is a hybrid electric vehicle (HEV) mode in which power is obtained by operating both an electric vehicle and an engine. Hybrid electric vehicles switch the two modes in accordance with in-driving conditions.

Other than classification of driving modes according to powertrains described above, particularly, the driving modes of plug-in hybrid electric vehicles (PHEV) can also be classified into a charge depleting (CD) mode and a charge sustaining (CS) mode based on variation of the state of charge (SOC) of a battery. In general, driving is performed by driving an electric motor using the power of a battery in the CD mode, and the power of an engine is usually used in the CS mode such that the SOC of a battery is not decreased.

Switching of these driving modes is generally performed for the purpose of maximizing fuel efficiency or driving efficiency, depending on the efficiency characteristics of powertrain. As a result, the control methods for switching of the driving modes focus only on efficiency of operating eco-friendly vehicles, which is far from the ultimate goal that eco-friendly vehicles should aim for.

In order to solve these problems, a technology of activating green zone control in areas (e.g., school, hospital, park, residential area, mart, and school zone) where exhaust gas emission limits are determined, within a predetermined distance from “my home” set in a navigation, in the case when a green zone is activated after a previous driving cycle is finished, or within a predetermined distance after a next driving cycle, based on navigation information has been developed.

However, since such related art activates green zone control based on navigation information, it is impossible to designate areas that drivers want as green zones.

Further, when air conditioning or catalyst heating is required, green zone control is limited, so green zone control is not activated even though entering the same areas, which may lead to a misunderstanding for drivers that the green zone control is inconsistent.

Further, in this technical field, there is a need for a technology that can set specific roads as green zones and drive a vehicle in accordance with selection of a driver and can inform a driver whether a current driving road is a green zone and whether green zone control has been activated in a currently driving vehicle through a visualization means such as a display image.

### SUMMARY

An objective of the present disclosure is to drive a vehicle after specific roads as green zones in accordance with selection of a driver.

Another objective of the present disclosure is to inform a driver whether a current driving road is a green zone through a visualization means such as a display image.

Another objective of the present disclosure is to inform a driver whether green zone control has been activated in a currently driving vehicle through a visualization means such as a display image.

The technical subjects to implement in the present disclosure are not limited to the technical problems described above and other technical subjects that are not stated herein will be clearly understood by those skilled in the art from the following specifications.

In order to achieve the objectives described above, a method of controlling driving of a vehicle according to an embodiment of the present disclosure includes receiving information about a current driving road, when existence of at least one of a first section and a second section where exhaust gas emissions are limited is determined based on the received information, determining whether driving is possible in a first mode of driving using only an electric motor in the section determined as existing, and outputting information about the section determined as existing in consideration of whether driving is possible in the first mode, wherein the first section is set by a driver and the second section is set in advance based on information set in advance in an external server or a memory of the vehicle.

When driving is possible in the first mode, visual effects different from each other may be applied to the first section and the second section in the outputting.

When driving is impossible in the first mode, the same visual effect corresponding to the fact that driving is impossible in the first mode may be applied to both of the first section and the second section in the outputting.

The method of controlling driving may further include controlling a driving source of the vehicle to drive in the first mode in the section determined as existing.

A range of the first section may be set based on a start point a detailed link dividing a driving path based on a preset reference.

A start point and an end point of the first section may be set based on distances from the start point of the detailed link.

Whether driving is possible in the first mode in the first section may be determined based on powertrain information.

The powertrain information may include a state of charge of a battery, requested power of the vehicle, or available output power of a motor, or at least one or more of combinations thereof.

The method of controlling driving may further include receiving information for setting the first section, storing a start point of the first section when a setting request for the first section is received, storing an end point of the first section when a setting end request for the first section is received, and transmitting information about the first section to the external server or the memory.

The setting request for the first section and the setting end request for the first section may be received through a physical button or a display screen installed adjacent to a driver seat.

Meanwhile, an apparatus for controlling driving of a vehicle according to an embodiment of the present disclosure includes an information collector configured to receive information about a current driving road, and a processor configured to, when existence of at least one of a first section and a second section where exhaust gas emissions are limited is determined based on the received information, determine whether driving is possible in a first mode of driving using only an electric motor in the section determined as existing, and output information about the section determined as existing in consideration of whether driving is possible in the first mode, wherein the first section is set by a driver and the second section is set in advance based on information set in advance in an external server or a memory of the vehicle.

When driving is possible in the first mode, the processor may apply visual effects different from each other to the first section and the second section.

When driving is not possible in the first mode, the processor may apply the same visual effect corresponding to the fact that driving is impossible in the first mode to both of the first section and the second section.

The processor may control a driving source of the vehicle to drive in the first mode in the section determined as existing.

A range of the first section may be set based on a start point a detailed link dividing a driving path based on a preset reference.

A start point and an end point of the first section may be set based on distances from the start point of the detailed link.

Whether driving is possible in the first mode in the first section may be determined based on powertrain information.

The powertrain information may include a state of charge of a battery, requested power of the vehicle, or available output power of a motor, or at least one or more of combinations thereof.

The processor may receive information for setting the first section, store a start point of the first section when a setting request for the first section is received, store an end point of the first section when a setting end request for the first section is received, and transmit information about the first section to the external server or the memory.

The setting request for the first section and the setting end request for the first section may be received through a physical button or a display screen installed adjacent to a driver seat.

According to the embodiments of the present disclosure described above, the commercial value of a vehicle is improved by changing software without changing the hardware of a hybrid electric vehicle.

Further, the usability of a hybrid electric vehicle in an atmospheric environment protection mode is increased.

Further, the commercial value of a vehicle is improved by applying individualized setting of a driver to the atmospheric environment protection mode of a hybrid electric vehicle.

Further, a driver is informed of an atmospheric environment protection mode operation section of a hybrid electric vehicle, whereby satisfaction to corresponding functions can be increased.

The effects that can be obtained by the present disclosure are not limited to the effects described above and other effects can be clearly understood by those skilled in the art from the following description.

### BRIEF DESCRIPTION OF THE DRAWINGS

FIG. 1 shows an example of the configuration of a powertrain of a hybrid electric vehicle according to an embodiment of the present disclosure;

FIG. 2 shows an example of the configuration of a control system of the hybrid electric vehicle according to an embodiment of the present disclosure;

FIG. 3 is a block diagram schematically showing an apparatus for controlling driving of a vehicle according to an embodiment of the present disclosure;

FIG. 4 shows an example of a physical button for setting individual green zones according to an embodiment of the present disclosure;

FIG. 5 shows an example when a section type of a road ahead of a vehicle has been determined in accordance with an embodiment of the present disclosure;

FIG. 6 shows an example of setting an individual green zone region according to an embodiment of the present disclosure;

FIG. 7 shows an example of a display image for setting an individual green zone according to an embodiment of the present disclosure;

FIG. 8 shows an example when a section type of a road ahead of a vehicle has been displayed in a display image in accordance with an embodiment of the present disclosure;

FIG. 9 shows an example when a notification is displayed in a display image when it is impossible to control a driving source of a vehicle that is suitable for the section type shown in FIG. 8;

FIG. 10 is a flowchart showing a method of setting a green zone for a vehicle according to an embodiment of the present disclosure; and

FIG. 11 is a flowchart showing a method of controlling driving of a vehicle according to an embodiment of the present disclosure.

### DETAILED DESCRIPTION

Hereafter, embodiments of the present disclosure will be described in detail with reference to the accompanying drawings and the same or similar components are given the same reference numerals regardless of the numbers of figures and are not repeatedly described. Terms “module” and “unit” that are used for components in the following description are used only for the convenience of description without having discriminate meanings or functions. In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the specification, the technical spirit disclosed in the specification is not limited by the accompanying drawings, and all changes, equivalents, and replacements should be understood as being included in the spirit and scope of the present disclosure.

Terms including ordinal numbers such as “first” and “second” may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element with the other element therebetween. On the other hand, it should be understood that when one element is referred to as being “connected directly to” or “coupled directly to” another element, it may be connected to or coupled to another element without the other element therebetween.

Singular forms are intended to include plural forms unless the context clearly indicates otherwise.

It will be further understood that the terms “comprise” or “have” used in this specification specify the presence of stated features, steps, operations, components, parts, or a combination thereof, but do not preclude the presence or addition of one or more other features, numerals, steps, operations, components, parts, or a combination thereof.

A unit or a control unit included in names such as an MCU (motor control unit) and an HCU (hybrid control unit) is only a term that is generally used to name a controller that controls specific functions of a vehicle rather than meaning a generic function unit. For example, each control unit may include a communication device that communicates with another control unit or a sensor to control corresponding functions, a memory that stores an operating system or logic commands and input/output information, and one or more processors that perform determination, calculation, decision, etc. for controlling the corresponding functions.

Before describing a method of controlling a hybrid electric vehicle according to embodiments of the present disclosure, the structure and control system of a hybrid electric vehicle that can be applied to embodiments are described first.

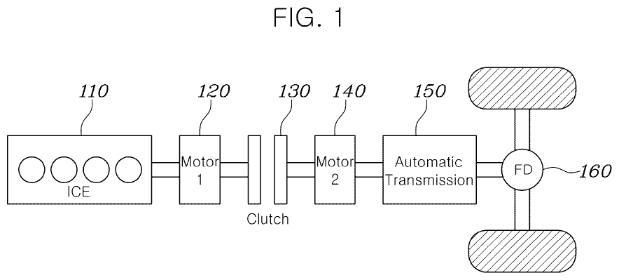

FIG. 1 shows an example of the configuration of a powertrain of a hybrid electric vehicle according to an embodiment of the present disclosure.

Referring to FIG. 1, a powertrain of a hybrid electric vehicle including a parallel-type hybrid system equipped with two motors 120 and 140 and an engine clutch 130 between an engine (internal combustion engine (ICE)) 110 and a transmission 150 is shown. Such a parallel-type hybrid system is also called a transmission mounted electric drive (TMED) hybrid system because the motor 140 is always connected to the input side of the transmission 150.

A first motor 120 of the two motors 120 and 140 is disposed between the engine 110 and a first side of the engine clutch 130, and an engine shaft of the engine 110 and a first motor shaft of the first motor 120 are directly connected to each other, whereby they can always rotate together.

In this configuration, the first motor 120 may be directly connected to the engine as in the structure of FIG. 1, but is not limited thereto and has only to be connected always. For example, the engine 110 and the first motor 120 may have a pulley-belt connection structure.

A first end of a second motor shaft of a second motor 140 may be connected to a second side of the engine clutch 130 and a second end of the second motor shaft may be directly connected to the input side of the transmission 150.

The second motor 140 has large power in comparison to the first motor 120 and can function as a driving motor. The first motor 120 can function as a starter motor that cranks the engine 110 when the engine 110 is started, can collect rotation energy of the engine 110 by generating electricity when the engine is stopped, and can generate electricity using the power from the engine 110 when the engine 110 is in operation.

In a hybrid electric vehicle having the powertrain shown in FIG. 1, when a driver starts the vehicle (e.g., HEV ready) and then depresses the accelerator pedal, the second motor 140 is driven first by the power of a battery (not shown) with the engine clutch 130 open. Accordingly, the power from the second motor 140 is transmitted to the transmission 150 and a final drive (FD) 160, whereby wheels are moved (i.e., EV mode). When larger driving force is needed while the vehicle is gradually accelerated, the first motor 120 is operated and can crank the engine 110.

When the rotation speed difference between the engine 110 and the second motor 140 comes into a predetermined range after the engine 110 is started, the engine clutch 130 is finally engaged and the engine 110 and the second motor 140 are rotated together (i.e., transition into an HEV mode from an EV mode). Accordingly, the power of the second motor 140 decreases and the power of the engine 110 increases through torque blending, whereby it is possible to satisfy the torque requested by the driver. In the HEV mode, the engine 110 can satisfy most of requested torque and the difference between the engine torque and the requested torque can be compensated by at least one of the first motor 120 and the second motor 140. For example, when the engine 110 outputs torque larger than requested torque in consideration of efficiency of the engine 110, the first motor 120 or the second motor 140 generates electricity by the surplus of the engine torque. However, when the engine torque is smaller than requested torque, at least one of the first motor 120 and the second motor 140 can output torque by the shortage.

When a predetermined engine-off condition such as deceleration of the vehicle is satisfied, the engine clutch 130 is opened and the engine 110 is stopped (i.e., transition into the EV mode from the HEV mode). A battery is charged by the second motor 140 using the driving force of wheels in deceleration, which is called braking energy regeneration or regenerative braking.

In generally, the transmission 150 may be a discontinuously variable transmission or a multi-plate clutch, for example, a dual clutch transmission (DCT).

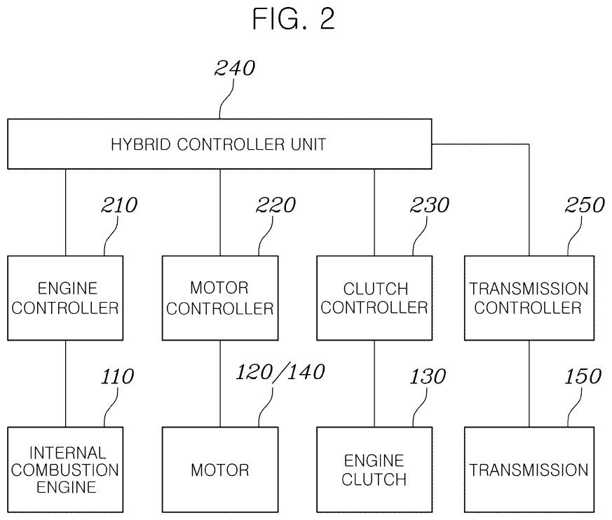

FIG. 2 shows an example of the configuration of a control system of the hybrid electric vehicle according to an embodiment of the present disclosure.

Referring to FIG. 2, in a hybrid electric vehicle to which embodiments of the present disclosure can be applied, an engine control unit 210 can control the internal combustion engine 110, torque of the first motor 120 and the second motor 140 can be controlled by a motor control unit (MCU) 220, and a clutch control unit 230 can control the engine clutch 130. In this configuration, the engine control unit 210 may be referred to as an engine management system (EMS). A transmission control unit 250 controls the transmission 150.

The motor control unit 220 can control a gate drive unit (not shown) using a pulse width modulation (PWM) type of control signal based on a motor angle, a phase voltage, a phase current, requested torque, etc. of each of the motors 120 and 140, and the gate drive unit can control an inverter (not shown) that drives each of the motors 120 and 140.

The control units are connected to a hybrid controller unit (HCU) 240 that controls the entire powertrain including a mode change process as an upper control unit, thereby being able to provide a driving mode change, information for controlling the engine clutch in shifting, and/or information for stopping the engine to the hybrid controller unit 240 or to perform operations according to control signals under control by the hybrid controller unit 240.

For example, the hybrid controller unit 240 determines whether to switch the EV and HEV modes or CD and CS modes (in a PHEV), depending on the driving state of the vehicle. To this end, the hybrid controller unit determines the point in time of opening the engine clutch 130 and performs hydraulic control when the engine clutch 130 is opened. The hybrid controller unit 240 can determine the states (lock-up, slip, open, etc.) of the engine clutch 130 and can control the point in time of stopping fuel injection of the engine 110. The hybrid controller unit can control collection of rotation energy of the engine by transmitting a torque instruction for controlling the torque of the first motor 120 to the motor control unit 220 to control engine stop. The hybrid controller unit 240, in order to satisfy requested torque, can determine the states of the driving sources 110, 120, and 140, determine requested driving force that the driving sources 110, 120, and 140 are supposed to separately take over, and transmit a torque instruction to the control units 210 and 220 that control the driving sources.

Of course, it is apparent to those skilled in the art that the connection relationship of the control units and the functions/discrimination of the control units described above are only examples and are not limited to the names. For example, the hybrid controller unit 240 may be implemented such that a corresponding function is replaced and provided by any one of the other control units, or the corresponding function may be separately provided by two or more of the other control units.

The configuration described with reference to FIGS. 1 and 2 is only an exemplary configuration of a hybrid electric vehicle and it will be apparent to those skilled in the art that a hybrid electric vehicle that can be applied to embodiments is not limited to the structure described above.

Meanwhile, the concept of areas that are influenced by emission of exhaust gases is described.

An area that is influenced by emission of exhaust gases may be an area set in advance or may be variably set in accordance with the current/recent situation. In this case, areas set in advance may be areas set under rules, government policies, or the like (e.g., emission control areas in London, Seoul, or the like), areas where emission reduction is needed due to local characteristics (e.g., school zone, indoor parking lot, residential area, park, drive-thru, hospital, etc.), etc. Areas variably set may be an area where current setting can be checked through wireless information such as telematics, a pedestrian crowded area determined through a vision information acquisition device (ADAS system), etc. In detail, such areas may be areas corresponding to the case when air quality conditions in a specific area has deteriorated according to reference to air environment information, the case when an area where pedestrians are densely concentrated is identified based on big data using the location information of smartphones, the case when it is estimated that a large amount of exhaust gas will be generated based on an average vehicle speed and a traffic volume collected through a telematic service, etc.

Further, areas that are influenced by exhaust gas emissions may be set in the unit of arbitrary administrative district, may be set as sections connecting a plurality of coordinates that are boundary points, and may be set as sections within a predetermined radius from specific facility itself/some part of it or specific facility/coordinate.

Of course, the setting examples are only examples and embodiments of the present disclosure are not limited to those setting references, setting ranges, setting periods, etc.

In the following description, an area that is influenced by exhaust gas emissions is referred to as a green zone for the convenience of description.

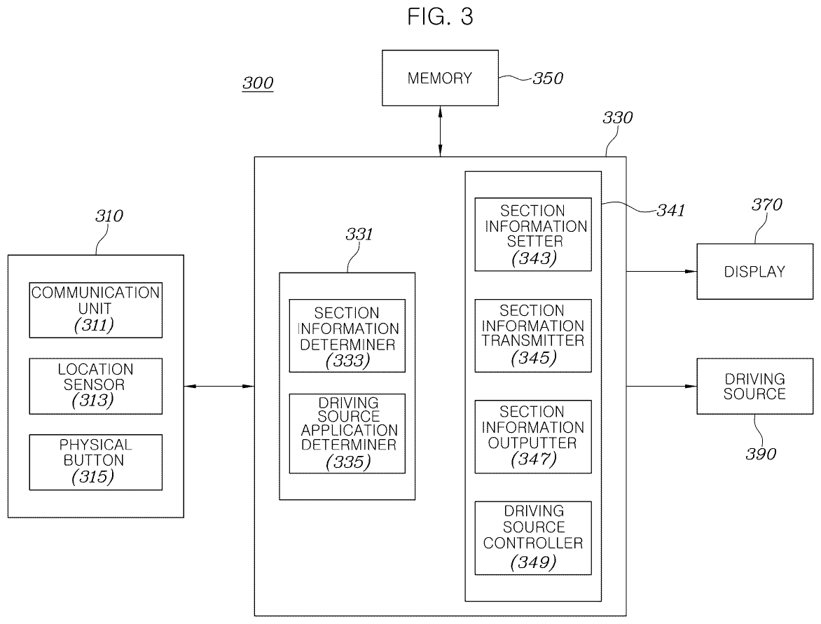

FIG. 3 is a block diagram schematically showing an apparatus for controlling driving of a vehicle according to an embodiment of the present disclosure.

Referring to FIG. 3, an apparatus 300 for controlling driving of a vehicle according to this embodiment includes an information collector 310, a processor 330, a memory 350, a display 370, and a driving source 390.

The information collector 310 collects information for controlling driving of the vehicle.

The information collector 310 includes a communication unit 311, allocation sensor 313, and a physical button 315.

The communication unit 311 is connected with the processor 330 and directly obtains information or transmits and/or receives information of an external server (not shown). For example, the communication unit 311 receives map information from an external server and transmits and receives the type of a section to which a driving road pertains.

In this case, the external device, for example, may be a navigation server.

The location sensor 313 may be a Global Positioning System (GPS) sensor and can receive information about the current location of the vehicle from a GPS satellite.

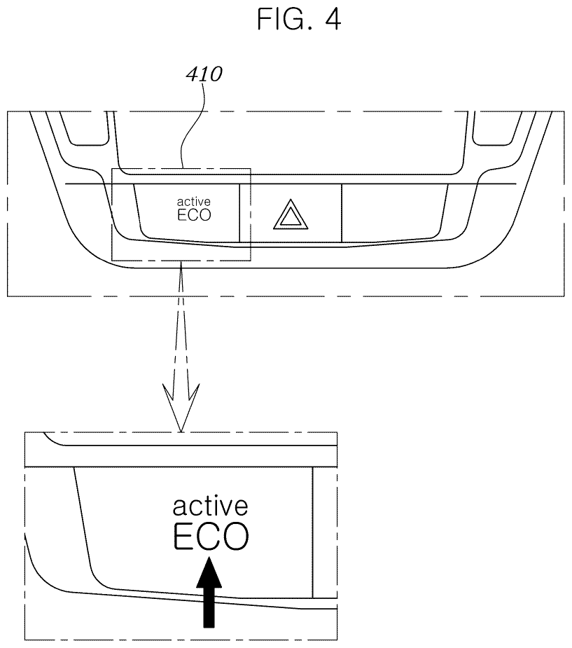

The physical button 315 senses whether a driver operates a button. The physical button 315 may be provided in various types, and for example, may be provided in the type of the physical button 410 shown in FIG. 4.

The processor 330 controls driving of the vehicle and includes a determiner 331 that determines the driving modes of the vehicle and a controller 341 that controls the vehicle in accordance with the determined driving modes of the vehicle.

The determiner 331 includes a section information determiner 333 and a driving source application determiner 335.

The section information determiner 333 determines the current driving road of the vehicle and the type of the section to which a forward expected driving road pertains based on the map information, the current location of the vehicle, and the information about the section to which the driving road of the vehicle pertains that are received from the information collector 310.

In this case, the forward expected driving road may be determined based on a driving path based on destination information on a navigation set by a driver.

In this case, the type of a section to which the type of the current driving road of the vehicle pertains, for example, may include an individual green section and a general green section.

Meanwhile, in the specification, an individual green section is determined as a green section set in advance by a driver and a general green section is defined as a green section determined based on information received from an external server or a vehicle.

In the specification, an individual green zone may be defined as a first section and a general green zone may be defined as a second section.

Accordingly, an individual green zone may be information stored in advance in an external server or the memory 350 in the vehicle by a driver and a general green zone may be information stored in an external server or the memory in the vehicle regardless of a driver.

In this configuration, the information type determiner 333, as shown in FIG. 3, can determine a section type within a preset distance of a forward expected driving road from the current location of the vehicle and can determine the range of the section based on a distance from a start point of a detailed link of the forward road.

In this case, when there is no navigation destination information set by a user, a road with the highest possibility of entering within the preset distance in the current driving direction can be determined.

In this case, the road with the highest possibility of entering can be determined based on traffic information of each of roads and detailed links stored in an external server.

In this case, a detailed link is defined as a unit dividing a road based on a preset reference, and the point close to the vehicle of both ends of a detailed link may be defined as the start point of the detailed link and the point far from the vehicle may be defined as the end point of the detailed link.

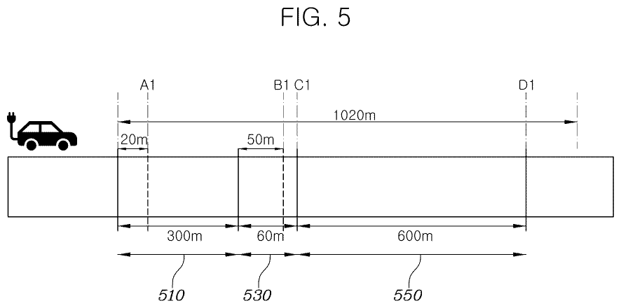

For example, referring to FIG. 5, the section information determiner 333 can determine section information within 1020 m from the current position of the vehicle and first to third links 510, 530, and 550 may be included in a range where section information can be determined.

In this case, an individual green zone may be determined as the range from A1 that is a point 20 m away from the start point of the first link 510 to B1 that is a point 50 m away from the start point of the second link 530 based on information set in advance by the driver.

Further, a general green zone may be determined as the range from C1 that is the start point of the third link 550 and D1 that is the end point of the third link 550.

The driving source application determiner 335 determines whether the vehicle can be driven in the driving mode corresponding to the section information determined by the section information determiner 333 based on the section information and powertrain information.

For example, the driving mode may include an EV mode in which the motors 120 and 140 are used for driving and an engine mode in which the internal combustion engine 110 is used for driving.

In this case, the EV mode may be defined as a first mode and the engine mode may be defined as a second mode.

In this case, when an individual green zone or a general green zone is included in the forward expected driving road of the vehicle, the driving source application determiner 335 can determine whether the vehicle can be driven in the EV mode in the individual green zone or the general green zone.

In this case, the powertrain information may include the state of charge of a battery, requested power of the vehicle, or the available output power of the motors 120, and 140, or at least one or more of combinations thereof.

In this case, the driving source application determiner 335 can determine whether the vehicle can be driven the whole distance in the EV mode in the individual green zone or the general green zone based on the powertrain information.

In this case, whether the vehicle can be driven in the EV mode in the individual green zone or the general green zone can be determined based on the result of comparing the required SOC and the current SOC of the battery depending on the length of the range of the individual green zone or the general green zone and the result of comparing the requested power of the vehicle and the available output power of the motors 120 and 140.

In this case, when the vehicle can be driven in the EV mode in the individual green zone, the driving source application determiner 335 transmits a question about whether to drive in the EV mode to the driver, and when a response is received from the driver, the driving source application determiner 335 can transmit the information to the driving source controller 349 so that the information is reflected to control of the driving sources.

The controller 341 includes a section information setter 343, a section information transmitter 345, a section information outputter 347, and a driving source controller 349.

The section information setter 343 sets the range of an individual green zone in response to a request from the driver.

In this case, the section information setter 343 can set the range of an individual green zone based on information received from the physical button 315 disposed adjacent to the driver seat.

In this case, when the driver presses the physical button 315 first, the section information setter 343 can set the current location of the vehicle as the start point of the individual green zone, and when the driver presses the physical button 315 second, the section information setter 343 can set the current location of the vehicle as the end point of the individual green zone.

In this case, after the end point of the individual green zone is set, when the driver presses again the physical button 315, the start point of another individual green zone can be set.

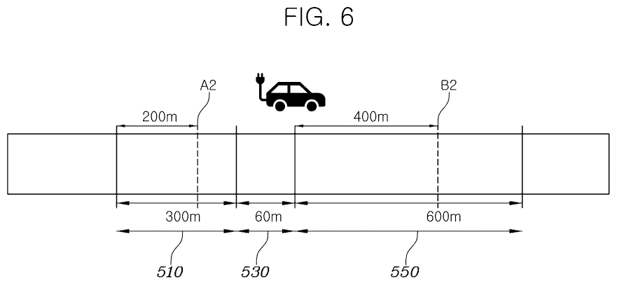

In this case, the section information setter 343, as shown in FIG. 6, can determine the start point and the end point of an individual green zone based on distances from the start point of a detailed link of a current driving road.

In this case, a detailed link is defined as a unit dividing a driving path based on a preset reference, and the point that the vehicle already passed of both ends of a detailed link may be defined as the start point of the detailed link and the point positioned ahead of the vehicle may be defined as the end point of the detailed link. Further, the point that the vehicle passed first of both ends of a detailed link may be defined as the start point of the detailed link and the point that the vehicle passed later may be set as the end point of the detailed link.

For example, referring to FIG. 6, the driver can set the start point of an individual green zone A2 by pressing the physical button 315 at the point 200 m away from the start point of the first link 510 and can set the end point B2 of the individual green zone B2 by pressing the physical button 315 at the point 400 m away from the start point of the third link 550 after the start point and the end point of the second link 530.

Referring to FIG. 3 again, the section information setter 343 can set the zone within a preset radius from the point where the driver pressed the physical button 315 as an individual green zone.

Further, the section information setter 343 can set the range of an individual green zone based on information received from the display 370 disposed adjacent to the driver seat.

In this case, the section information setter 343 can set a point that the driver touched first on a map image as the start point of an individual green zone and can set a point that the driver touched second as the end point of the individual green zone.

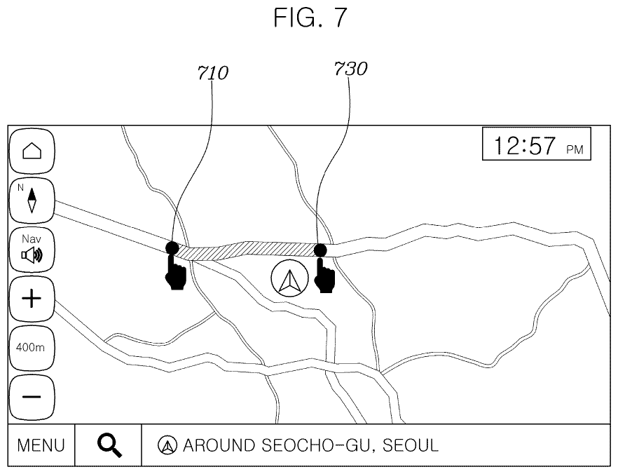

For example, when a map image shown in FIG. 7 is displayed on the display 370, the driver can set the start point and the end point of an individual green zone by sequentially touching a first point 710 and a second point 730.

Referring to FIG. 3 again, the section information transmitter 345 can set the zone within a preset radius from a point that the driver touched on a map image of the display 370 as an individual green zone.

Further, the section information transmitter 345 transmits the range of an individual green zone set by the section information setter 343 to an external server (not shown) or the memory 350 through the communication unit 311.

The section information outputter 347 displays the section information determined by the section information determiner 333 on the map displayed on the display 370.

In this case, the information determined by the section information determiner 333 may include an individual green zone and a general green zone.

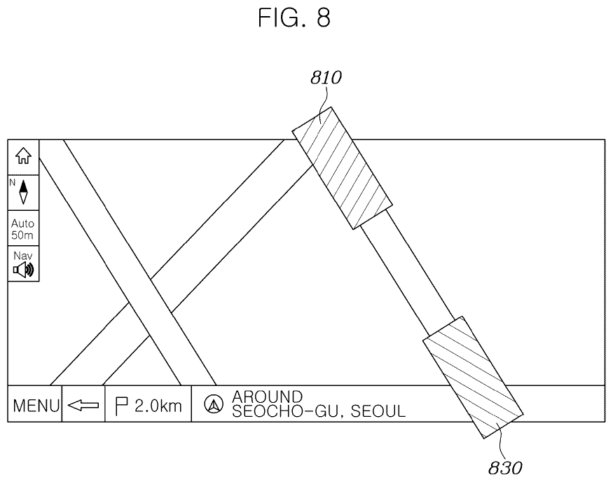

For example, referring to FIG. 8, the section information outputter 347 can separately show an individual green zone 810 and a general green zone 830 on a map displayed on the display 370.

For example, the section information outputter 347 can show the individual green zone 810 and the general green zone 830 as boxes with colors different from each other or boxes with patterns different from each other.

For example, the section information outputter 347 can show the individual green zone 810 as a green box and the general green zone as a yellow box.

In this case, the general green zone may include information about school zones, schools, hospitals, and residential areas.

In this case, the section information outputter 347 can show detailed information of the school zones, schools, hospitals, and residential areas shown on the map displayed on the display 370.

Meanwhile, the section information outputter 347 can show information determined by the driving source application determiner 335 together with the section information on the map displayed on the display 370.

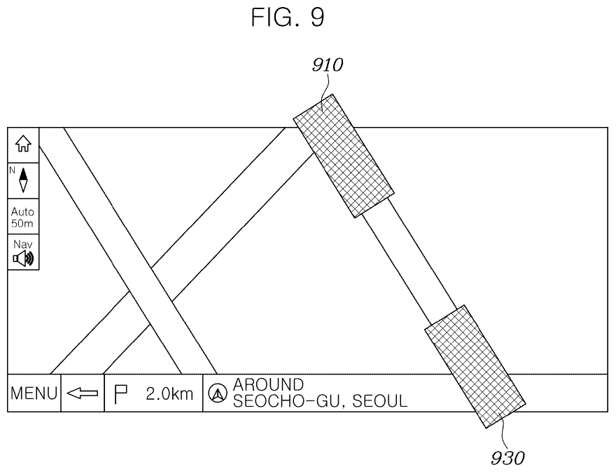

For example, referring to FIG. 9, the section information outputter 347 can show an individual green zone 910 and a general green zone 930 on a map displayed on the display 370 and can show whether the vehicle can be driven in the driving mode corresponding to the section information in the individual green zone 910 and the general green zone 930.

For example, when the vehicle can be driven in the driving mode corresponding to the section information, the section information outputter 347, as shown in FIG. 8, can separately show an individual green zone 810 and a general green zone 830 on the map displayed on the display 370.

For example, the section information outputter 347 can show the individual green zone 810 and the general green zone 830 as boxes with colors different from each other or boxes with patterns different from each other.

For example, the section information outputter 347 can show the individual green zone 810 as a green box and the general green zone 830 as a yellow box.

In this case, when the vehicle cannot be driven in the driving mode corresponding to the section information, the section information outputter 347 can show the individual green zone and the general green zone as boxes with colors different from those when the vehicle can be driven in the driving mode corresponding to the section information, or boxes with patterns different from each other.

For example, when the vehicle cannot be driven in the driving mode corresponding to section information in the individual green zone 910 or the general green zone 930, the section information outputter 347, as in FIG. 9, can show the individual green zone 910 or the general green zone 930 as a purple box.

Referring to FIG. 3 again, the driving source controller 349 controls the driving source 390 based on information determined by the driving source application determiner 335.

In this case, when receiving a response of the driver about whether to drive the vehicle in the EV mode from the driving source application determiner 335, the driving source controller 349 can control the driving source 390 based on the response.

Meanwhile, the driving source controller 349 can control the driving source 390 based on information determined by the driving source application determiner 335 in accordance with setting by the driver and information about the current time or the current date.

For example, the driving source controller 349 activates or inactivates an individual green zone and a general green zone, depending on the current time or the current date, thereby being able to set the vehicle to be driven in the driving mode corresponding thereto.

The memory 350 may be various types of volatile memory or nonvolatile media. In this case, the memory 350 can store map information, information about the current location of the vehicle, detailed link information of roads, monitoring information of the physical button 315, individual green information, or general green information, or at least one or more combinations thereof.

The display 370 can provide a map on the screen and can receive destination information, and information about the range of an individual green zone from the driver through a voice, a touch screen, or the like to provide navigation.

Further, the display 370 provide the driver with section information, notification about entering or leaving the section, and notification about whether the vehicle can be driven in the driving mode corresponding to the section information through displaying an image or outputting a voice.

In this case, the display 370 may include a navigation screen with a touch screen or a head up display (HUD).

The driving source 390 provides power to the vehicle under control by the driving source controller 349. In this case, the driving source 390 may include the internal combustion engine 110 and the motors 120 and 140.

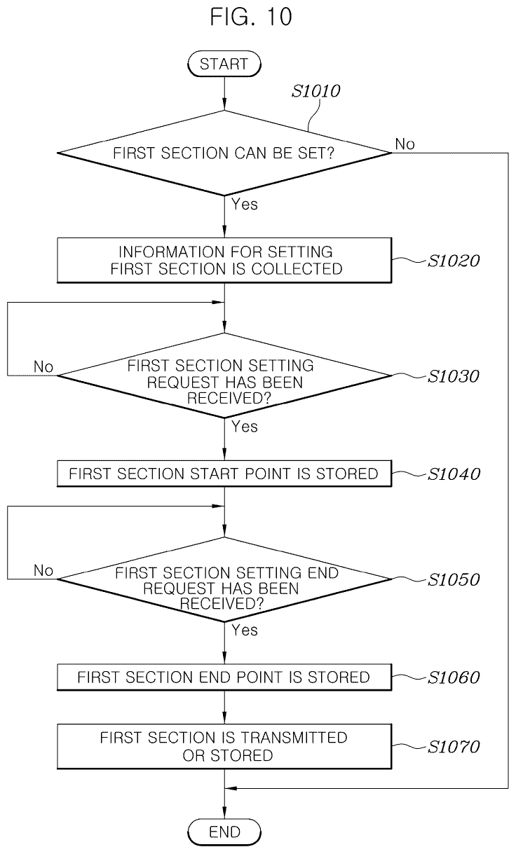

FIG. 10 is a flowchart showing a method of setting a green zone for a vehicle according to an embodiment of the present disclosure.

The method of setting a green zone for a vehicle according to this embodiment can be performed by the apparatus 300 for controlling driving of a vehicle shown in FIG. 3.

Referring to FIG. 3, the apparatus 300 for controlling driving determines whether it is possible to currently set an individual green zone, that is, a first section for a vehicle (S1010).

In this case, whether it is possible to set a first section may include whether it is possible, in the vehicle, to switch a first mode of driving the vehicle using the motors 120 and 140 and a second mode of driving the vehicle using the internal combustion engine 110.

When it is possible to currently set the first section for the vehicle as the result of determination in step S1010, the apparatus 300 for controlling driving collects information for setting the first section (S1020).

In this case, the information for setting the first section may include map information, information about the current location of the vehicle, detailed link information of roads, and monitoring information of the physical button 315.

Further, the apparatus 300 for controlling driving determines whether a first section setting request by the driver has been received (S1030), and stores information about a first section start point when receiving the first section setting request (S1040).

In this case, when input is received through the physical button 315 or a touch screen of the display 370, it is possible to determine that the first section setting request has been received, by monitoring the physical button 315 or the touch screen.

In this case, when input is received through the physical button 315, the current location of the vehicle can be set as the start point of the first section.

In this case, when input is received through the touch screen, the position where the input has been received on a map through the touch screen can be set as the start point of the first section.

Further, the apparatus 300 for controlling driving determines whether a first section setting end request by the driver has been received (S1050), and stores information about a first section start point when receiving the first section setting end request (S1060).

In this case, when second input is received through the physical button 315 or a touch screen of the display 370, it is possible to determine that the first section setting end request has been received, by monitoring the physical button 315 or the touch screen.

In this case, when second input is received through the physical button 315, the current location of the vehicle can be set as the end point of the first section.

In this case, when second input is received through the touch screen, the position where the second input has been received on a map through the touch screen can be set as the end point of the first section.

Further, the apparatus 300 for controlling driving transmits the information of the first section to an external server or stores the information of the first section in the memory 350 (S1070).

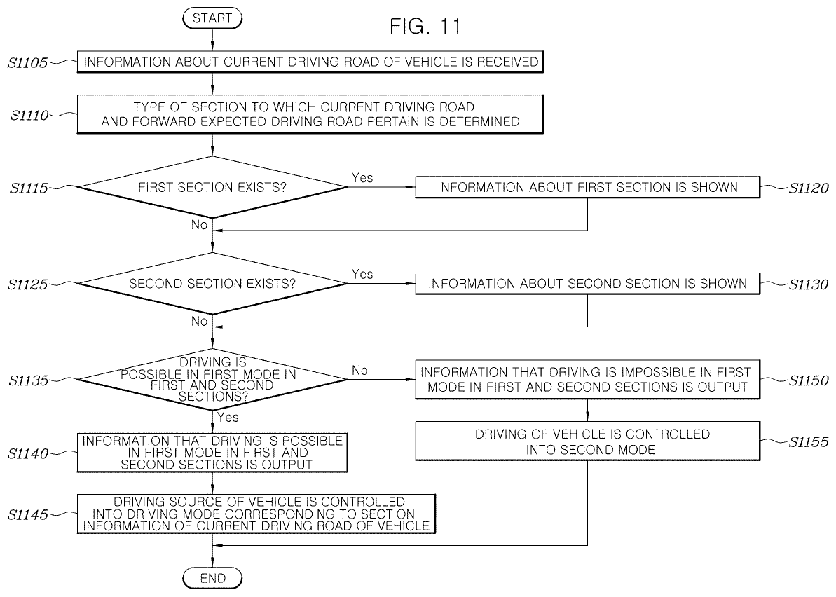

FIG. 11 is a flowchart showing a method of controlling driving modes of a vehicle according to an embodiment of the present disclosure.

The method of controlling driving modes of a vehicle according to this embodiment can be performed by the apparatus 300 for controlling driving of a vehicle shown in FIG. 3.

Referring to FIG. 11, the apparatus 300 for controlling driving receives information about a current driving road of a vehicle (S1105).

In this case, the information about the current driving road may include map information, detailed link information of the road, and information about first and second sections.

Further, the apparatus 300 for controlling driving determines the type of the section to which the current driving road and a forward expected driving road, that is, the driving path pertains (S1110).

In this case, the type of the section to which the driving path pertains, for example, may include a first section corresponding to an individual green zone and a second section corresponding to a general green zone.

In this case, the first section may be a section set by the driver and the second section may be a section set in advance based on navigation information.

In this case, the navigation information may be information set in advance in the memory 350 of the vehicle.

Further, the apparatus 300 for controlling driving determines whether a first section exist on the driving path (S1115), and shows information about the first section on the display 370 when the first section exists on the driving path (S1120).

In this case, the information about the first section can be shown in a navigation image or a head up display (HUD) image.

Further, the apparatus 300 for controlling driving determines whether a second section exist on the driving path (S1125), and shows information about the second section on the display 370 when the second section exists on the driving path (S1130).

In this case, the information about the second section can be shown in a navigation image or a head up display (HUD) image.

In this case, visual effects different from each other may be applied to the first section and the second section.

Further, the apparatus 300 for controlling driving determines whether the vehicle can be driven in a first mode in the first and second sections (S1135), and outputs information that the vehicle can be driven in the first mode in the first and second sections when the vehicle can be driven in the first mode in the first and second sections (S1140).

In this case, the apparatus 300 for controlling driving determines whether the vehicle can be driven in the driving mode corresponding to section information based on the section information and powertrain information.

For example, the driving mode may include an EV mode in which the motors 120 and 140 are used for driving and an engine mode in which the internal combustion engine 110 is used for driving.

In this case, the EV mode may be defined as a first mode and the engine mode may be defined as a second mode.

In this case, when a first section or a second section is included in the driving path of the vehicle, the apparatus 300 for controlling driving can determine whether the vehicle can be driven in a first mode corresponding to an EV mode in the first section or the second section.

In this case, the powertrain information may include the state of charge of a battery, requested power of the vehicle, or the available output power of the motors 120, and 140, or at least one or more of combinations thereof.

In this case, the apparatus 300 for controlling driving determines whether the vehicle can be driven the whole distance in the first mode in the first section or the second section based on the powertrain information.

In this case, whether the vehicle can be driven the hole distance in the EV mode in an individual green zone or a general green zone can be determined based on the result of comparing the required SOC and the current SOC of the battery depending on the length of the range of the individual green zone or the general green zone and the result of comparing the requested power of the vehicle and the available output power of the motors 120 and 140.

In this case, when the vehicle can be driven in the driving mode corresponding to section information, the apparatus 300 for controlling driving, as shown in FIG. 8, can separately show a first section corresponding to an individual green zone 810 and a second section corresponding to a general green zone 830 on the map displayed on the display 370.

For example, the apparatus 300 for controlling driving can show the first section 810 and the second section 830 as boxes with colors different from each other or boxes with patterns different from each other.

For example, the section information outputter 347 can show the first section 810 as a green box and the second section 830 as a yellow box.

Further, the apparatus 300 for controlling driving controls the driving source of the vehicle in the driving mode corresponding to the section information of the current driving road of the vehicle (S1145).

In this case, the apparatus 300 for controlling driving can control driving of the vehicle in the driving mode corresponding to the section information of the current driving road of the vehicle by controlling the driving source 390 of the vehicle.

In this case, the driving source 390 may include the internal combustion engine 110 and the motors 120 and 140.

Meanwhile, when the vehicle cannot be driven in the first mode in the first and second sections as the result of determination in step S1135, the apparatus outputs information that the vehicle cannot be driven in the first mode in the first and second sections (S1150) and controls driving of the vehicle in a second mode different from the first mode (S1155).

In this case, when the vehicle cannot be driven in the first mode in the first and second sections, the apparatus 300 for controlling driving can shows the sections with colors or patterns that are different from those when the vehicle can be driven in the first mode.

In this case, the same visual effect corresponding to the fact that the vehicle cannot be driven in the first mode may be applied to the first section and the second section.

For example, the apparatus 300 for controlling driving can show the first and second sections as purple boxes when the vehicle cannot be driven in the first mode in the first and second sections.

In this case, the second mode may correspond to the engine mode of driving using the internal combustion engine 110.

According to the embodiments of the present disclosure described above, the commercial value of a vehicle is improved by changing software without changing the hardware of a hybrid electric vehicle.

Further, the usability of a hybrid electric vehicle in an atmospheric environment protection mode is increased.

Further, the commercial value of a vehicle is improved by applying individualized setting of a driver to the atmospheric environment protection mode of a hybrid electric vehicle.

Further, a driver is informed of an atmospheric environment protection mode operation section of a hybrid electric vehicle, whereby satisfaction to corresponding functions can be increased.

Meanwhile, the present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage. Accordingly, the detailed description should not be construed as being limited in all respects and should be construed as an example. The scope of the present disclosure should be determined by reasonable analysis of the claims and all changes within an equivalent range of the present disclosure are included in the scope of the present disclosure.

What is claimed is:

1. A method of controlling driving of a vehicle, the method comprising:
receiving, by an information collector, information about a current driving road;
when existence of at least one of a first section and a second section where exhaust gas emissions are limited is determined based on the received information, determining whether driving is possible in a first mode of driving using only an electric motor in the section determined as existing; and
outputting information about the section determined as existing when driving is possible in the first mode;
wherein the first section is set by a driver and the second section is set in advance based on information set in advance in an external server or a memory of the vehicle.

2. The method of claim 1, wherein when driving is possible in the first mode, applying different visual effects to the first section and the second section in the outputting of information.

3. The method of claim 1, wherein when driving is not possible in the first mode, applying same visual effects corresponding to the driving not being in the first mode to both of the first section and the second section in the outputting of information.

4. The method of claim 3, further comprising controlling a driving source of the vehicle to drive in the first mode in the section determined as existing.

5. The method of claim 1, wherein a range of the first section is set based on a start point of a detailed link dividing a driving path based on a preset reference.

6. The method of claim 5, wherein a start point and an end point of the first section are set based on distances from the start point of the detailed link.

7. The method of claim 1, wherein whether driving is possible in the first mode in the first section is determined based on powertrain information.

8. The method of claim 7, wherein the powertrain information comprises at least one of a state of charge of a battery, requested power of the vehicle, or available output power of a motor, or one or more of combinations thereof.

9. The method of claim 1, further comprising:
receiving information for setting the first section;
storing a start point of the first section when a setting request for the first section is received;
storing an end point of the first section when a setting end request for the first section is received; and
transmitting information about the first section to the external server or the memory.

10. The method of claim 9, wherein the setting request for the first section and the setting end request for the first section are received through a physical button or a display screen installed adjacent to a driver seat.

11. An apparatus for controlling driving of a vehicle, the apparatus comprising:
an information collector configured to receive information about a current driving road; and
a processor configured to, when existence of at least one of a first section and a second section where exhaust gas emissions are limited is determined based on the received information, determine whether driving is possible in a first mode of driving using only an electric motor in the section determined as existing, and output information about the section determined as existing when driving is possible in the first mode;
wherein the first section is set by a driver and the second section is set in advance based on information set in advance in an external server or a memory of the vehicle.

12. The apparatus of claim 11, wherein when driving is possible in the first mode, the processor is configured to apply different visual effects to the first section and the second section.

13. The apparatus of claim 11, wherein in response that driving is not possible in the first mode, the processor is configured to apply same visual effects corresponding to the driving not being possible in the first mode to both of the first section and the second section.

14. The apparatus of claim 13, wherein the processor controls a driving source of the vehicle to drive in the first mode in the section determined as existing.

15. The apparatus of claim 11, wherein a range of the first section is set based on a start point of a detailed link dividing a driving path based on a preset reference.

16. The apparatus of claim 15, wherein a start point and an end point of the first section are set based on distances from the start point of the detailed link.

17. The apparatus of claim 11, wherein whether driving is possible in the first mode in the first section is determined based on powertrain information.

18. The apparatus of claim 17, wherein the powertrain information comprises a state of charge of a battery, requested power of the vehicle, or available output power of a motor, or one or more combinations thereof.

19. The apparatus of claim 11, wherein the processor is further configured to:
receive information for setting the first section;
store a start point of the first section when a setting request for the first section is received;
store an end point of the first section when a setting end request for the first section is received; and
transmit information about the first section to the external server or the memory.

20. The apparatus of claim 19, wherein the setting request for the first section and the setting end request for the first section are received through a physical button or a display screen installed adjacent to a driver seat.
